(19) United States
(12) Patent Application Publication
(10) Pub. No.: US 2015/0144278 A1
(43) Pub. Date: May 28, 2015

(54) Molded Guide Rail

(71) Applicant: Macauto Industrial Co., Ltd., Tainan City (TW)

(72) Inventors: Paul Lin, Tainan City (TW); Hung-Ming Yen, Tainan City (TW)

(73) Assignee: Macauto Industrial Co., Ltd., Tainan City (TW)

(21) Appl. No.: 14/093,021

(22) Filed: Nov. 28, 2013

(51) Int. Cl. E06B 9/58

(52) U.S. Cl. CPC E06B 9/58
USPC 160/368.1

(57) ABSTRACT

A molded guide rail is described. The molded guide rail includes a main body, a guide groove, a plurality of first limiting parts and a plurality of second limiting parts. The guide groove extends and passes through the main body. The first limiting parts and the second limiting parts are respectively connected to the main body at two opposite sides of the guide groove and partially cover the guide groove. A combination of the main body, the first limiting parts and the second limiting parts is an integrated structure.

### BACKGROUND

1. Field of Invention

The present invention relates to a guide rail. More particularly, the present invention relates to a molded guide rail.

2. Description of Related Art

In some roller blind apparatuses, blinds are driven by sliding members moving in guide rails, so that the blinds can be rolled up or rolled down. Currently, a guide rail of such a roller blind apparatus typically includes at least two molded members, and the guide rail is fabricated by embedding or wedging one molded member into the other molded member.

However, in the method for manufacturing such a guide rail, at least two molds are formed for manufacturing the two molded members, and the molded members are combined to form the guide rail. Thus, the cost for manufacturing the molds is high, and the fabrication is manpower-consuming and time-consuming, so that the manufacturing cost of the guide rail is greatly increased, and the throughput cannot be effectively enhanced.

### SUMMARY

Therefore, one aspect of the present invention is to provide a molded guide rail, in which a combination of a plurality of the first limiting parts and a plurality of second limiting parts, which are respectively disposed at two opposite sides of a guide groove, and a main body is an integrated structure formed by using a mold. Therefore, the number of components of the guide rail is decreased, thereby reducing the cost for manufacturing and the fabricating of the guide rail.

Another aspect of the present invention is to provide a molded guide rail, in which a bottom end of a guide groove is set with a plurality of openings, so that a molded technique of shut off and kiss off can be used to successfully manufacture an integrated guide rail.

According to the aforementioned objectives, the present invention provides a molded guide rail. The molded guide rail includes a main body, a guide groove, a plurality of first limiting parts and a plurality of second limiting parts. The guide groove extends and passes through the main body. The first limiting parts and the second limiting parts are respectively connected to the main body at two opposite sides of the guide groove and partially cover the guide groove. A combination of the main body, the first limiting parts and the second limiting parts is an integrated structure.

According to an embodiment of the present invention, the main body, the first limiting parts and the second limiting parts are formed from plastics.

According to another embodiment of the present invention, the first limiting parts correspond to the second limiting parts by a one to one method.

According to still another embodiment of the present invention, a bottom end of the guide groove includes a plurality of openings, and locations of the openings respectively correspond to locations of the first limiting parts and the second limiting parts.

According to further another embodiment of the present invention, a center of each of the first limiting parts is directly opposite to a center of the corresponding second limiting part.

According to yet another embodiment of the present invention, a length of each of the first limiting parts is equal to a length of the corresponding second limiting part and a length of the corresponding opening.

According to still further another embodiment of the present invention, a length of each of the first limiting parts is equal to a length of the corresponding second limiting part, and the length of each of the first limiting parts is smaller than a length of the corresponding opening.

According to still further another embodiment of the present invention, a center of each of the first limiting parts and a center of the corresponding second limiting part are staggered.

According to still further another embodiment of the present invention, a range of a length of each of the openings is equal to or greater than a range of a length of a combination of the corresponding first limiting part and the corresponding second limiting part.

According to still further another embodiment of the present invention, each of the first limiting parts and the corresponding second limiting part are staggered.

According to still further another embodiment of the present invention, a range of a length of each of the openings is equal to or greater than a range of a length of a combination of the corresponding first limiting part and corresponding second limiting part.

### BRIEF DESCRIPTION OF THE DRAWINGS

The invention can be more fully understood by reading the following detailed description of the embodiment, with reference made to the accompanying drawings as follows:

FIG. 1 is a three-dimensional diagram showing a molded guide rail in accordance with an embodiment of the present invention;

FIG. 2 illustrates a cross-sectional view of the molded guide rail shown in FIG. 1 along a cross-sectional line A-A; and

FIG. 3 illustrates a cross-sectional view of the molded guide rail shown in FIG. 1 along a cross-sectional line B-B.

### DETAILED DESCRIPTION

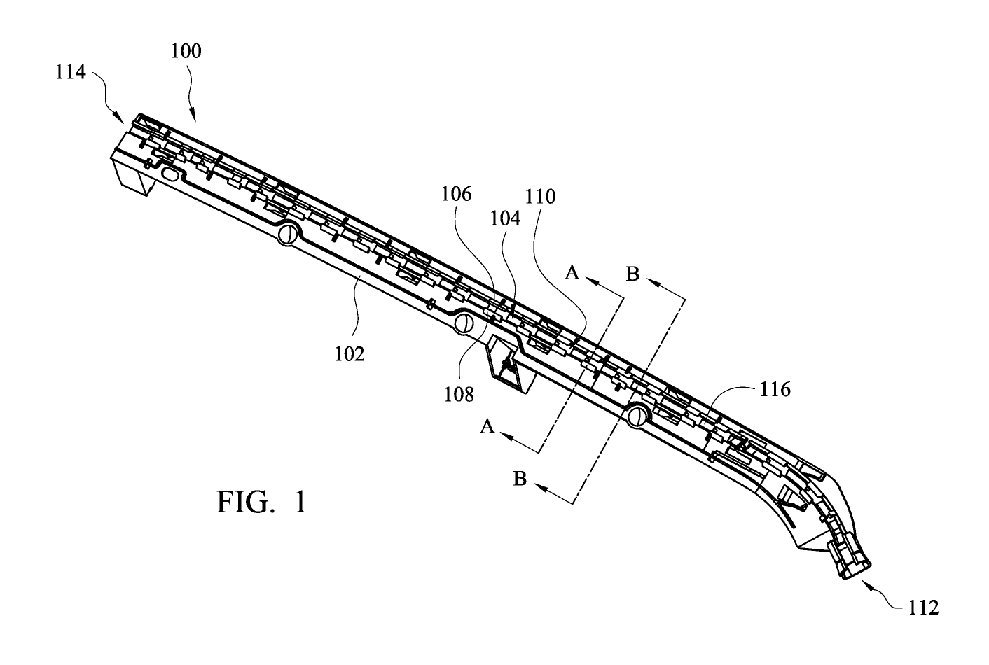

Refer to FIG. 1. FIG. 1 is a three-dimensional diagram showing a molded guide rail in accordance with an embodiment of the present invention. In the present embodiment, a molded guide rail 100 may be applied on an electric roller blind apparatus, such as a window blind apparatus or a blocking blind apparatus for a motor vehicle, to guide a sliding member for driving a blind.

In some exemplary embodiments, the molded guide rail 100 mainly includes a main body 102, a guide groove 104, a plurality of first limiting parts 106 and a plurality of second limiting parts 108. In some exemplary example, the main body 102, the first limiting parts 106 and the second limiting parts 108 are formed from plastics. Thus, the whole molded guide rail 100 can be manufactured by an injection molding method with a mold. Therefore, a combination of the main body 102, the first limiting parts 106 and the second limiting parts 108 is an integrated structure.

The main body 102 may be a long strip structure. In addition, a length of the main body 102 can be modified according to a length of a desired blind. The main body 102 has a first end 112 and a second end 114 opposite to each other. The guide groove 104 extends and passes through the main body 102 along a length direction of the main body 102. That is, the guide groove 104 extends and passes through the main body 102 from the first end 112 to the second end 114 of the main body 102. A sliding member (not shown) connected to a blind can slide within the guide groove 104. Thus, the blind can be driven and be rolled down or rolled up by the sliding of the sliding member within the guide groove 104.

The first limiting parts 106 are connected to the main body 102 at one side of the guide groove 104. The first limiting parts 106 are arranged at the side of the guide groove 104 sequentially and discontinuously. In addition, each first limiting part 106 obliquely extends from the main body 102 toward the top and the inner side of the guide groove 104 to partially cover the top of the guide groove 104. On the other hand, the second limiting parts 108 are connected to the main body 102 at the other side of the guide groove 104. The second limiting parts 108 and the first limiting parts 106 are respectively located at the two opposite sides of the guide groove 104. Similarly, the second limiting parts 108 are arranged at the other side of the guide groove 104 sequentially and discontinuously. Furthermore, each second limiting part 108 obliquely extends from the main body 102 toward the top and the inner side of the guide groove 104 to partially cover the top of the guide groove 104. The sliding member sliding within the guide groove 104 can be prevented from coming off the guide groove 104 by respectively disposing the first limiting parts 106 and the second limiting parts 108 at the two opposite sides of the guide groove 104.

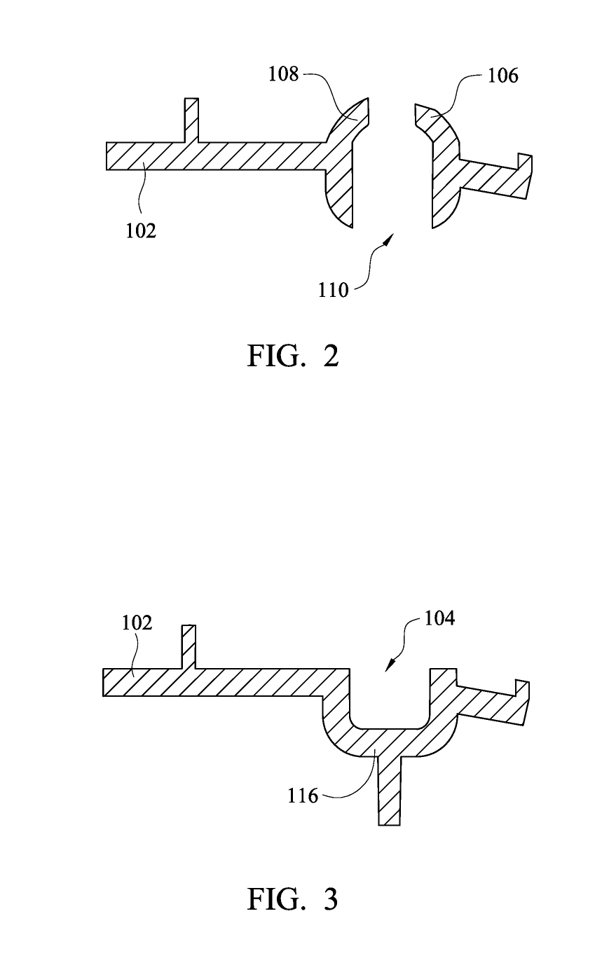

In some exemplary embodiments, the first limiting parts 106 correspond to the second limiting parts 108 by a one to one method. That is, the first limiting parts 106 and the second limiting parts 108 have the same number. Refer to FIG. 2 and FIG. 3. FIG. 2 and FIG. 3 respectively illustrate cross-sectional views of the molded guide rail shown in FIG. 1 along a cross-sectional line A-A and a cross-sectional line B-B. In the present embodiment, a bottom end 116 of the guide groove 104 includes a plurality of openings 110. The openings 110 are discontinuously disposed in the bottom end 116, so that the portions of the bottom end 116, where the openings 110 are not formed, can connect the portions of the main body 102 at the two sides of the guide groove 104, and the whole molded guide rail 100 is an integrated structure. Locations of the openings 110 respectively correspond to locations of the first limiting parts 106 and the second limiting parts 108.

In some exemplary embodiments, referring to FIG. 1 again, a center of each first limiting part 106 is directly opposite to a center of the corresponding second limiting part 108. In such embodiments, a length of each first limiting part 106 may be equal to a length of the corresponding second limiting part 108. In addition, in some exemplary examples, a length of the opening 110 may be equal to that of the first limiting part 106 and that of the second limiting part 108, each of which has a location corresponding to the location of the opening 110. In certain exemplary examples, the length of the opening 110 may be greater than those of the corresponding first limiting part 106 and the corresponding second limiting part 108. Certainly, in the example, in which the center of each first limiting part 106 is directly opposite to the center of the corresponding second limiting part 108, the length of each first limiting part 106 may be different from that of the corresponding second limiting part 108. In addition, the length of the opening 110 may be equal to or greater than that of one of the corresponding first limiting part 106 and the corresponding second limiting part 108, which has a larger length than that of the other one. For example, when the length of the first limiting part 106 is greater than that of the second limiting part 108, the length of the opening 110 is equal to or greater than that of the corresponding first limiting part 106.

In some exemplary embodiments, the center of each first limiting part 106 is indirectly opposite to the center of the corresponding second limiting part 108. A range of the length of each opening 110 is equal to or greater than a range of a length of a combination of the corresponding first limiting part 106 and the corresponding second limiting part 108. That is, the range of the length of each opening 110 can cover the combination of the corresponding first limiting part 106 and the corresponding second limiting part 108, including a overlapping portion of the first limiting part 106 and the corresponding second limiting part 108, a portion of the first limiting part 106 non-overlapping with the second limiting part 108 and a portion of the second limiting part 108 non-overlapping with the first limiting part 106.

In some certain embodiments, each first limiting part 106 and the corresponding second limiting part 108 are not overlapping and are staggered. In some examples, the range of the length of each opening 110 is equal to or greater than the range of the length of the combination of the corresponding first limiting part 106 and corresponding second limiting part 108. That is, the range of the length of each opening 110 can cover the combination of the corresponding first limiting part 106 and the corresponding second limiting part 108, including the first limiting part 106, the second limiting part 108, and a gap formed between the first limiting part 106 and the second limiting part 108 along the extending direction of the guide groove 104. In certain examples, the number of the openings 110 is equal to the sum of the numbers of the first limiting parts 106 and the second limiting parts 108. In addition, the locations of the openings 110 respectively correspond to the locations of the first limiting parts 106 and the second limiting parts 108, and the length of each opening 110 is equal to or greater than that of the corresponding first limiting part 106 or that of the corresponding second limiting part 108.

In the aforementioned examples, the range of the length of each opening 110 is equal to or greater than that of the corresponding first limiting part 106, that of the corresponding second limiting part 108, or that of the combination of the corresponding first limiting part 106 and the corresponding second limiting part 108, so that when the molded guide rail 100 is manufactured by using a plastic injection molding technique, such as a shut off and kiss off technique, the portions of the mold used to form the first limiting parts 106 and the second limiting parts 108 can be drawn off from the openings 110 to successfully take off the mold, so as to form the integrated molded guide rail 100.

According to the aforementioned embodiments, one advantage of the present invention is that a combination of a plurality of the first limiting parts and a plurality of second limiting parts, which are respectively disposed at two opposite sides of a guide groove of a molded guide rail, and a main body is an integrated structure formed by using a mold, so that the number of components of the guide rail is decreased, thereby reducing the cost for manufacturing and the fabricating of the guide rail.

According to the aforementioned embodiments, another advantage of the present invention is that a bottom end of a guide groove of a molded guide rail is set with a plurality of openings, so that an injection molding technique, such as a shut off and kiss off molding technique, can be used to successfully manufacture an integrated guide rail.

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A molded guide rail, comprising:
a main body;
a guide groove extending and passing through the main body; and
a plurality of first limiting parts and a plurality of second limiting parts respectively connected to the main body at two opposite sides of the guide groove and partially covering the guide groove, wherein a combination of the main body, the first limiting parts and the second limiting parts is an integrated structure.

2. The molded guide rail of claim 1, wherein the main body, the first limiting parts and the second limiting parts are formed from plastics.

3. The molded guide rail of claim 1, wherein the first limiting parts correspond to the second limiting parts by a one to one method.

4. The molded guide rail of claim 3, wherein a bottom end of the guide groove includes a plurality of openings, and locations of the openings respectively correspond to locations of the first limiting parts and the second limiting parts.

5. The molded guide rail of claim 4, wherein a center of each of the first limiting parts is directly opposite to a center of the corresponding second limiting part.

6. The molded guide rail of claim 5, wherein a length of each of the first limiting parts is equal to a length of the corresponding second limiting part and a length of the corresponding opening.

7. The molded guide rail of claim 5, wherein a length of each of the first limiting parts is equal to a length of the corresponding second limiting part, and the length of each of the first limiting parts is smaller than a length of the corresponding opening.

8. The molded guide rail of claim 4, wherein a center of each of the first limiting parts and a center of the corresponding second limiting part are staggered.

9. The molded guide rail of claim 8, wherein a range of a length of each of the openings is equal to or greater than a range of a length of a combination of the corresponding first limiting part and the corresponding second limiting part.

10. The molded guide rail of claim 4, wherein each of the first limiting parts and the corresponding second limiting part are staggered.

11. The molded guide rail of claim 10, wherein a range of a length of each of the openings is equal to or greater than a range of a length of a combination of the corresponding first limiting part and corresponding second limiting part.
